(19) United States
(12) Patent Application Publication
(10) Pub. No.: US 2018/0036834 A1
(43) Pub. Date: Feb. 8, 2018

(54) METHOD AND APPARATUS FOR FRICTION WELDING

(71) Applicant: KUKA INDUSTRIES GMBH, Augsburg (DE)

(72) Inventors: Manfred MENZINGER, Kissing (DE); Stefan OHM, Todtenweis (DE); Andreas KLETT, Kissing (DE); Walter WEH, Jettingen-Scheppach (DE); Erwin VÖTTERL, Petersdorf (DE)

(21) Appl. No.: 15/552,074

(22) PCT Filed: Feb. 17, 2016
(86) PCT No.: PCT/EP2016/053339

§ 371 Date: Aug. 18, 2017

(30) Foreign Application Priority Data
Feb. 19, 2015 (DE) 10 2015 102 353.9

(51) Int. Cl. B23K 20/227; B23K 20/12

(52) U.S. Cl. CPC B23K 20/227; B23K 20/129; B23K 20/121; B23K 2201/06

(57) ABSTRACT

A method and apparatus for friction welding of workpieces (2, 3), which are softened and welded in a friction phase (R) with frictional contact and under frictional pressure (p) in a relative rotational movement about a process axis (8) through the effect of frictional heat. The frictional pressure (p) applied during axial advancement of one of the workpieces (3) is preferably ramped and increased during the friction phase (R).

### CROSS REFERENCE TO RELATED APPLICATIONS

This application is a United States National Phase Application of International Application PCT/EP2016/053339, filed Feb. 17, 2016, and claims the benefit of priority under 35 U.S.C. §119 of German Application 10 2015 102 353.9 filed Feb. 19, 2015, the entire contents of which are incorporated herein by reference.

### FIELD OF THE INVENTION

The present invention pertains to a method and a device for the friction welding of workpieces, which are plasticized and welded together by frictional heat during a friction phase in frictional contact and with a frictional pressure during a relative motion, especially a relative rotation about a process axis, and relates to a device for the friction welding of workpieces, wherein the friction welding device has workpiece mounts, a device producing a relative motion, especially a rotating device, and a pressing device for the workpieces as well as a control.

### BACKGROUND OF THE INVENTION

Such methods and devices for friction welding are known from practice. They are used for workpieces with relatively small diameters. A constant frictional pressure is used during the friction phase.

### SUMMARY OF THE INVENTION

The object of the present invention is to provide an improved friction welding technique.

Provisions are made in a basic aspect of the present invention for the frictional pressure (p) to be changed and increased during the duration of the friction phase (R). The pressing device of the friction welding device can be controlled correspondingly. The indicated pressure range with the change and increase between approx. 4 N/mm² and 100 N/mm² is advantageous. The pressure range with the increase from an initial value of about 5 N/mm² to 80 N/mm² is especially favorable. As an alternative, there may be other pressure ranges, especially higher end values of the frictional pressure under the above-mentioned basic aspect. The further particular features described relate to the said basic aspect. They have special advantages in conjunction with the specified pressure ranges, and they can also be used for other pressure ranges and thus they can be combined.

The friction welding technique, i.e., the method and the device for friction welding, have the advantage that the thermal conditions and thermal effects can be additionally and better controlled and optimized in the process during the friction phase. In particular, the introduction of heat and the temperature profile close to the contact and connection point between the workpieces can be influenced by the friction pressure rising only during the friction phase such that the maximum temperature affecting the hardness increase and the rate of cooling can be favorably influenced.

A reduction of the maximum temperature occurring in the components has advantages for the crystalline structure in metallic materials, especially those consisting of steel with a higher percentage of carbon, which tend to undergo a hardness increase and embrittlement at a higher rate of cooling. Embrittlement may be unfavorable for the strength and the service life above all for friction-welded components subject to dynamic stress. Such hardness increases and dynamic strength problems can be avoided or at least substantially reduced with the reduced rate of cooling. The increase in the frictional pressure can be adapted to the heating and cooling properties of the materials of which the workpieces consist.

It proved to be advantageous if the frictional pressure is increased steadily or continuously during the friction phase. This may take place in the form of a linear ramp, which is especially advantageous in case of workpieces consisting of steel with a higher carbon content. As an alternative, the frictional pressure may be increased stepwise or in increments. Further, wave-shaped pressure fluctuations are possible during the increase in the frictional pressure.

It further proved to be favorable if the frictional pressure is changed and increased during most of the frictional phase or during the entire frictional phase. In particular, the pressure increase may begin with a delay or with an offset in time from an initially low pressure level. The frictional pressure is higher at the end of the frictional phase than at the beginning.

The friction welding technique being claimed has further advantages. In particular, it makes possible the friction welding of workpieces with a markedly larger frictionally active diameter at the contact and connection point than was hitherto common. The workpieces may have a frictionally active diameter of 200 mm or larger, preferably 500 mm to 650 mm.

In addition, it is possible to work with a high rotational speed and with a markedly increased circumferential velocity compared to the state of the art during the relative motion of the workpieces at the contact and connection point. The workpieces may be rotated relative to one another during the friction phase (R) at the contact point at a circumferential velocity of, e.g., 5 m/sec or higher, preferably 12-17 m/sec, relative to one another. The frictional pressure (p) and the driving speed may be correspondingly coordinated and adapted during the duration of the friction phase (R). The friction welding device can be controlled correspondingly. The low initial pressure brings about a correspondingly lower frictional resistance in the rigid contacting workpiece edges. The frictional pressure can be increased with increasing frictional heating and plasticization of the workpiece edges. The workpieces are advantageously configured as pipes or have at least one tubular section in the area of the friction-welded connection.

Due to the frictional pressure increase being claimed, weaker rotating drives of the frictional welding device may be used or, as an alternative, workpieces with a markedly larger diameter at the contact and connection point can be friction-welded. In case of workpieces with large friction-welding diameters, the section modulus would be too high for normal rotating drives in case of the state-of-the-art friction welding technique with the very high initial frictional pressure, which remains constant during the friction phase, so that the friction welding of such workpieces is either impossible or requires a very special and oversized friction welding device.

Due to the claimed increase in the frictional pressure beginning with a markedly lower initial pressure, the section modulus can be reduced at the beginning of the friction phase to the extent that the rotating drive of a conventional friction welding machine can start. The frictional welding pressure can then be increased gradually, and the flywheel effect of the running rotating drive and/or of the masses is sufficient to overcome the increased resistance and to maintain the relative rotation and introduction of heat necessary for the frictional heating of the workpieces. It may further be favorable during the start phase to maintain the low frictional pressure at first at a constant value for a certain time and to increase it only thereafter. A linear ramp function is likewise advantageous here.

Despite the large workpiece diameters, it is possible to operate with a high speed of, e.g., about 500 rpm in case of the friction welding technique according to the present invention. Because of the large diameter, this leads to markedly higher circumferential velocities at the contact and connection area. Only a narrow contact and connection area is advantageously liquefied with a preferably slow increase in the frictional pressure and a high circumferential velocity, and partially melted material particles can also be expelled. This is associated with the removal of heat and a homogenization of the heating of the workpiece as well as with a reduction of the maximum temperature at the contact and connection area. These effects are favorable for the friction welding process and the heat and energy balance as well as the advantageous uniform material structure and crystalline structure in the friction-welded connection area. The above-mentioned rate of cooling and the avoidance of hardness increases and embrittlement are also favorably supported by this effect.

The friction welding device may have a control, with which a pressing device and a rotating device of the friction welding device are correspondingly actuated for implementing the method being claimed. The control may be programmable and may contain especially a friction welding program. Further, a technology data bank, which contains the friction welding parameters for different pairs of workpieces or calculation principles for generating and calculating such friction welding parameters, may be added. In addition, axial feed paths and friction welding shortenings as well as the overall length of the finished welded parts may be controlled or regulated.

The workpieces, especially those with very large friction welding diameters, are configured as pipes. They are fastened in a workpiece mount a suitable manner, especially by means of a clamping device. High radial clamping pressures, which stress the workpiece, are necessary for transmitting the high torques. The claimed arrangement of a support device supports these clamping pressures and prevents deformations of the workpiece. The friction welding technique being claimed is advantageous above all for a rotating and circulating relative motion of the workpieces. As an alternative, it can be used, with corresponding adaptation, in case of other friction welding techniques and kinematics of the relative motion, in which, e.g., a relative motion is an oscillating motion and/or a linear motion component and/or a pendular motion or the like is present.

The present invention is schematically described in the drawings as an example.

The present invention is described in detail below with reference to the attached figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view showing a friction welding device;

FIG. 2 is a diagram for the curve of the speed and the frictional pressure over time according to the present invention; and

FIG. 3 is a diagram for the curve of the speed according to the state of the art.

### DESCRIPTION OF THE PREFERRED EMBODIMENTS

Referring to the drawings, the present invention pertains to a method and to a device (1) for the friction welding of workpieces (2, 3).

The workpieces (2, 3) may be of any type and size and may consist of any material suitable for friction welding. The workpieces are preferably configured as pipes or have at least one tubular section in the area of the friction-welded connection.

The workpieces (2, 3) preferably consist of metal. In the following exemplary embodiments, they consist of steel with a higher carbon content, which tends to undergo a hardness increase at a higher rate of cooling. The workpieces (2, 3) may consist, in principle, of the same material or of different materials. There may be differences especially in terms of the melting point and the thermal conductivity. For example, material pairs of steel with cast materials, especially cast metal with graphite inclusions, iron and nonferrous metals and the like can be friction-welded. In addition, nonmetallic friction-welding partners are possible.

In the exemplary embodiments shown, the workpieces (2, 3) have very large frictionally active diameters at the contact and connection point (4). This diameter is 200 mm or larger. The diameter is preferably larger than 350 mm, especially preferably in the range of 500 mm to 650 mm.

For the friction welding, the workpieces (2, 3) to be connected to one another are moved and pressed along a central process axis (8) axially against one another and rotated relative to one another and in a circulating manner. The workpieces (2, 3) are pressed axially against one another with a defined frictional pressure (p) at the contact and connection point (4) during the relative rotation. Heat is introduced into the contact and connection point (4) due to the frictional resistance, and this heat leads to heating and partial melting of the workpieces (2, 3) in this area. The workpieces (2, 3) are subsequently pressed together with an upset stroke, and the relative rotation is ended beforehand or at the same time.

At the beginning of the friction welding process, the workpieces (2, 3) are spaced axially apart, and the rotary motion of one workpiece (2) is started. The workpieces (2, 3) are then brought axially closer to one another during the feed and brought into physical contact, and a frictional pressure (p) is applied on the circulating contact and connection area (4) by the axial pressing force (F). The feed into the already rotating workpiece (2) takes place on the fly in this variant. The beginning of the pressure increase on contact between the workpieces signals the actual position of the front edges of the workpieces to be welded together and is stored in the analysis unit as a so-called zero position. The zero position is significant for the control or regulation of the feed paths and of the desired end position of the welded part as well as of the workpiece shortenings.

In another variant, the workpieces (2, 3) may be brought into physical contact first without relative rotation in order to detect said zero position and the actual position based on the increase in pressure. They are then spaced again apart from one another somewhat, while the relative rotation starts and the axial feed takes place at the same time. The desired speed (n) is reached on physical contact in both variants.

Beginning from the physical contact with rotation, the friction phase (R) starts, in which the workpiece edges are plasticized by the heat under the frictional pressure on the contact and connection area (4) and a friction bead is possibly formed radially at the point (4) and the workpieces (2, 3) correspondingly continue to be brought axially closer to one another. At the end of the friction phase, the relative rotation or the rotating workpiece (2, 3) can be decelerated, and the axial pressing force is markedly increased during a so-called upset stroke at the time or shortly thereafter to provide the upsetting phase (S).

FIG. 3 shows for this a diagram for the curve of the frictional pressure (p) and of the speed (n) according to the state of the art in case of an application for large frictionally active diameters and usual circumferential velocities of about 3 m/sec with a correspondingly dimensioned friction welding device. The frictional pressure (p) is already very high right at the beginning of the friction phase (R) and remains constant during the friction phase. A conventional pressure value is, e.g., about 80 N/mm². The desired or nominal rotational speed (n) is likewise constant after a start phase and is about 100 rpm. Such a friction welding method with the conventional welding parameters (p, n) requires a very powerful rotating drive and an oversized machine design.

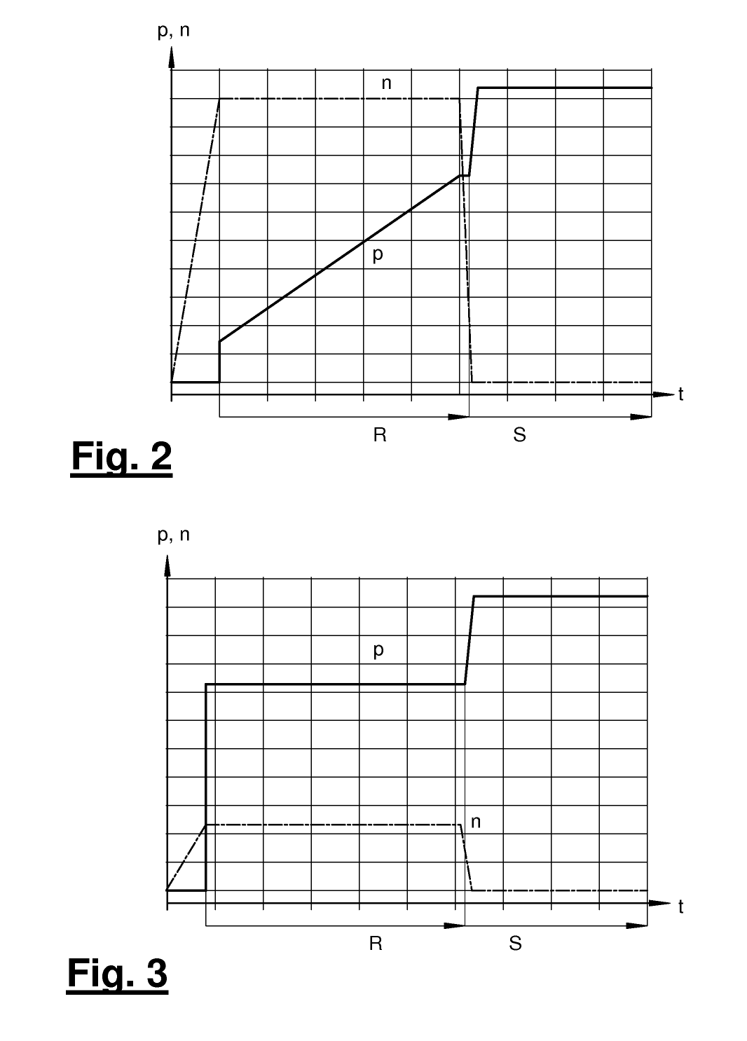

The diagram in FIG. 2 shows the friction welding method according to the present invention. The exemplary embodiment shown pertains here to workpieces (2, 3) consisting of steel, in which at least one workpiece (2, 3) has an increased carbon content and is prone to hardness increase. The frictionally active diameter of the workpieces (2, 3) is 560 mm.

The frictional pressure (p) is markedly lower at the beginning of the friction phase (R) than in the state of the art. It is, e.g., approx. 5 N/mm². It initially remains at this low level for some time to subsequently rise accordingly to a ramp and linearly up to a frictional pressure of, e.g., 80 N/mm² at the end of the friction phase (R).

The offset or the time delay until the beginning of the pressure increase may correlate with the start phase until the desired or nominal speed (n) is reached. As soon as the desired speed is reached, the frictional pressure (p) rises as well. The frictional pressure at the end of the friction phase (R) is approximately equal to that seen in the state of the art according to FIG. 3.

According to FIG. 2, the nominal speed (n) of the rotating drive (6) is also higher in the friction welding method according to the present invention than in the state of the art according to FIG. 3. It equals approx. 500 rpm. After the end of the start phase, it likewise remains constant until the end of the friction phase (R) and is then preferably abruptly reduced.

A circumferential velocity of about 14.4 m/sec is obtained at the desired or nominal speed (n) at the contact or connection area (4) in this exemplary embodiment. It is substantially higher than in the state of the art, where it is approx. 1 m/sec to 5 m/sec.

Different parameters may be obtained for other exemplary embodiments and friction welding pairs. The frictional pressure (p) is increased in a range of approx. 4 N/mm² to 100 N/mm² during the friction phase. At the end of the friction phase, the frictional pressure is always higher than at the beginning Unlike in the exemplary embodiment shown, the frictional pressure (p) may optionally also rise in one or more steps and optionally also in step-like increments or with a stepped ramp function. The frictional pressure (p) is preferably changed steadily or continuously during the friction phase (R). The pressure increase may also take place according to a nonlinear curve function.

Corresponding to the variable frictionally active diameter, the circumferential velocities may vary at the contact and connection area (4). They are preferably higher than 5 m/sec. A range between 12 m/sec and 17 m/sec is preferred. The predefined speed (n) maybe varied correspondingly.

The above-mentioned exemplary embodiment and the variants pertain to friction welding with a continuous motor drive for the relative motion and active deceleration of the motor drive. They may be correspondingly different for flywheel welding with moment of inertia and with the rotating drive switched off.

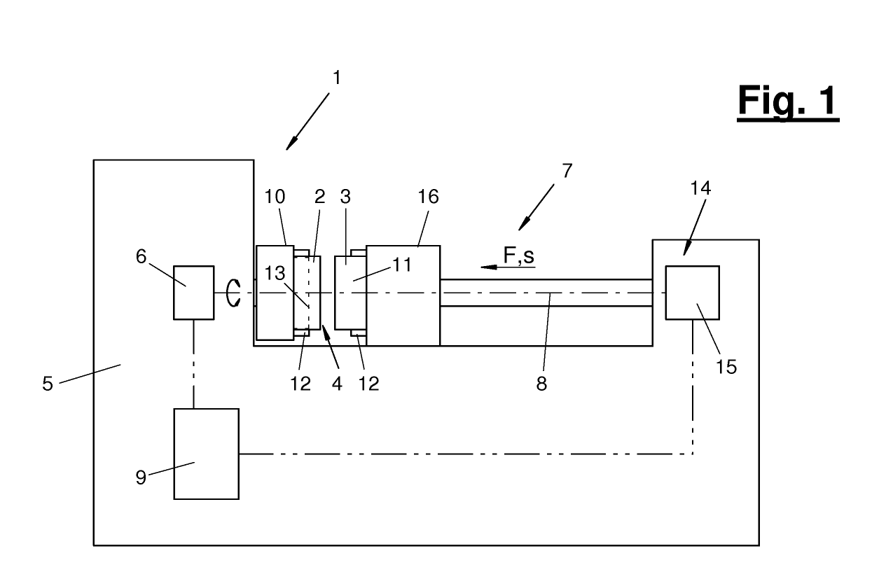

In the preferred embodiment shown, the friction welding device (1) may have a frame (5), on which a machine head with (6) and with a coupled workpiece mount (10) for the one workpiece (2) is arranged stationarily or axially movably. Further, a pressing device (7) with a workpiece mount (11) for the other workpiece (3) is arranged on the frame (5). It may be arranged, e.g., according to FIG. 1, axially opposite the machine head.

Two workpieces (2, 3) are friction-welded in the exemplary embodiment shown. In other variants, not shown, so-called double-head friction welding machines are possible, in which three or more workpieces are friction-welded to one another in one process.

In the exemplary embodiment shown, the rotating device (6) has a drive motor, which rotates the workpiece mount (10) arranged on a spindle about the process axis (8). This may be a direct drive or a drive with an interconnected transmission. The rotating device (6) may further have a braking device.

In another embodiment, not shown, the rotating drive may be configured as a flywheel drive, in which the drive motor sets a flywheel mass into rotation about the process axis (8), and this flywheel mass will then introduce the necessary kinetic energy during the friction welding process.

The drive motor is preferably configured as a controllable and optionally regulatable electric motor in the different embodiments. It may be configured as a d.c. motor or a.c. motor, especially as a three-phase motor.

The pressing device (7) ensures the axial approach of the workpieces (2, 3) over the path (s) and the pressing force or frictional force (F) acting in the process. The pressing device (7) may have any desired and suitable configuration and arrangement for this. It may generate axial pulling forces or forces of pressure.

In the preferred embodiment shown, it is configured as a feeding device (14). It has a feed drive (15) for feeding the workpiece mount (11) along the process axis (8). The feed drive is configured, e.g., as a hydraulic cylinder. As an alternative, it may also be configured as another linear drive, especially as an electrical spindle drive or the like. The feed drive (15) is controllable and also regulatable in conjunction with a suitable force- and/or displacement-detecting sensor system.

The feed drive (15), which is arranged and supported, e.g., stationarily on the frame (5), acts on a holder (16) mounted axially movably on the frame (5) by means of a rod-shaped feed element in the exemplary embodiment shown. The workpiece (11) is permanently or detachably fastened to the holder (16).

The workpiece mounts (10, 11) may have any desired and suitable configuration. In the exemplary embodiments shown, they are equipped with a clamping device (12), which clamps the workpiece (2, 3) radially from the outside or the inside. The clamping device (12) may have, e.g., a chuck with two or more radially adjustable clamping jaws.

To support the clamping forces, a support device (13), which is located opposite and acts against the clamping device (12), while supporting the clamping forces and the workpiece (2, 3), may be arranged at a workpiece (2, 3) to support the clamping forces. The support device (13) is arranged, e.g., in the rotating workpiece (2), but it may also be located at both or all workpieces (2, 3). It may be connected to the respective workpiece mount (10, 11) and held through the cavity of the workpiece (2, 3).

The friction welding device (1) has a preferably memory-programmable control (9), which is connected to the different components of the machine, especially to the rotating drive (6) and the feed drive (15) as well as to a sensor system, which detects the paths traveled by the friction welding partners and the acting forces. The control (9) controls the friction welding device (1) and the components thereof in a manner corresponding to the manner in which the aforementioned friction welding device is carried out. It may contain one or more stored friction welding programs. It may also have a technology data bank with ready-to-use friction welding parameters or friction welding parameters to be calculated as well as a suitable computer along with input and output interfaces.

Any desired variation of the above-described exemplary embodiments and of the variants is possible. In particular, the features of the different exemplary embodiments and variants may be combined and optionally also transposed with one another.

In particular, a different kinematics of the relative motion between the workpieces (2, 3) and a correspondingly different design configuration of the friction welding device (1) are possible.

Multiple rotating drives (6) and a different design configuration of the pressing device (7) are possible in other friction welding devices, especially double-head friction welding devices. In particular, a holder (16) fed by the pressing device (7) may have a rotating drive (6), wherein one or more additional workpieces and preferably workpieces held nonrotatably in relation to one another are arranged between the rotating workpieces. The pressing device (7) may also be connected to machine heads movable axially in both directions and move these axially in relation to one another as well as in relation to a central holder for a third workpiece or for additional workpieces.

In a variant of FIG. 1, a pressing device (7) may also be supported in a single-head friction welding machine on the side on a stationary holder (16), and said machine head is moved during the axial feed relative to the workpiece (3) located at a stationary holder (16). In one embodiment, a feed device (14) may be formed by cylinders, wherein the housing is connected to this axially movable machine head or headstock.

The friction welding device (1) may also be configured as a double single-head friction welding machine, which has a common central and stationary support device or holder (16) with workpiece mounts (11) on both sides and a mirror-symmetrical arrangement of machine heads with respective rotating drives (6) of their own along with pressing device (7). A pressing device (7) may be arranged in this embodiment as well as in other embodiments at the stationary or axially movable machine head shown in FIG. 1 with rotating drive (6) and exert pulling forces.

While specific embodiments of the invention have been shown and described in detail to illustrate the application of the principles of the invention, it will be understood that the invention may be embodied otherwise without departing from such principles.

1. A method for the friction welding of workpieces, the method comprising:
plasticizing and welding together the workpieces by frictional heat during a friction phase in frictional contact and with a frictional pressure during a relative motion about a process axis;
changing and increasing the frictional pressure during the duration of the friction phase in a range of about 4 N/mm², initially, to 100 N/mm².

2. (canceled)

3. A method in accordance with claim 1, wherein the frictional pressure is changed and increased during the friction phase steadily according to a linear ramp.

4. A method in accordance with claim 1, wherein the frictional pressure is changed and increased continuously during most of the friction phase or during the entire friction phase.

5. A method in accordance with claim 1, wherein the frictional pressure is increased from an initial value of 5 N/mm² to 80 N/mm² during the friction phase.

6. A method in accordance with claim 1, wherein the frictional pressure is applied along the process axis.

7. A method in accordance with claim 1, wherein workpieces are pressed axially against one another during an upset phase following the friction phase.

8. A method in accordance with claim 1, wherein workpieces with a frictionally active diameter of 200 mm or larger, preferably 500 mm to 650 mm, are friction-welded.

9. (canceled)

10. A method in accordance with claim 1, wherein the workpieces are rotated relative to one another during the friction phase at a speed of about 500 rpm.

11. A method in accordance with claim 1, wherein the workpieces are rotated relative to one another at a circumferential velocity of 5 m/sec or higher at a contact point during the friction phase.

12. A friction welding device for the friction welding of workpieces, which are plasticized and welded together in a friction phase by frictional heat in frictional contact and under the action of a pressing force during a relative rotation about a process axis, the friction welding device comprising:
workpiece mounts;
a rotating device producing relative motion
a pressing device for pressing the workpieces;
a control configured to control the pressing device such that the frictional pressure is changed and increased during the duration of a friction phase in a range of about 4 N/mm², initially, to 100 N/mm².

13. A friction welding device in accordance with claim 12, wherein the pressing device is controlled such that the frictional pressure is increased during the duration of the friction phase from an initial value of 5 N/mm² to 80 N/mm².

14. A friction welding device in accordance with claim 12, wherein the frictional pressure is increased during the friction phase steadily according to a linear ramp.

15. A friction welding device in accordance with claim 12, wherein the pressing device is controlled such that the frictional pressure is changed and increased continuously during most of the friction phase or during the entire friction phase.

16. A friction welding device in accordance with claim 12, wherein the rotating device and the pressing device are arranged and act along the central process axis.

17. A friction welding device in accordance with claim 12, wherein the pressing device is controlled such that the workpieces are pressed axially against one another following the friction phase during an upsetting phase with an increased upset force.

18. A friction welding device in accordance with claim 12, wherein the friction welding device is configured for workpieces with a frictionally active diameter of 200 mm or.

19. A friction welding device in accordance with claim 12, wherein the friction welding device is configured for workpieces comprised of steel with a higher carbon content.

20. A friction welding device in accordance with claim 12, wherein the rotating device is controlled such that the workpieces are rotated relative to one another at a speed (n) of about 500 rpm during the friction phase.

21. A friction welding device in accordance with claim 12, wherein the rotating device is controlled such that the workpieces are rotated relative to one another at a circumferential velocity of 5 m/sec or higher during the friction phase at a contact point.

22. A friction welding device in accordance with claim 12, wherein the friction welding device is configured for workpieces that are configured as pipes or have at least one tubular section in an area of the friction-welded connection.

23. (canceled)
